(19) United States
(12) Patent Application Publication
(10) Pub. No.: US 2025/0148051 A1
(43) Pub. Date: May 8, 2025

(54) METHOD FOR AUTOMATICALLY GENERATING REPORT AND ELECTRONIC DEVICE THEREOF

(71) Applicant: Wistron Corporation, New Taipei City (TW)

(72) Inventor: Ting-Ru Yang, New Taipei City (TW)

(73) Assignee: Wistron Corporation, New Taipei City (TW)

(21) Appl. No.: 18/536,137

(22) Filed: Dec. 11, 2023

(30) Foreign Application Priority Data
Nov. 2, 2023 (TW) 112142238

(51) Int. Cl. G06F 18/2415; G06F 40/30; G06Q 30/018

(52) U.S. Cl. CPC G06F 18/2415; G06F 40/30; G06Q 30/018

(57) ABSTRACT

Disclosed are a method for automatically generating a report and an electronic device thereof. The method includes: converting a questionnaire file through an artificial intelligence (AI) model to obtain a topic data set, where the topic data set includes multiple topics identified from the questionnaire file; performing text analysis on historical document data through a deep learning model to filter out a reference data set that matches the topic data set from the historical document data; obtaining response content corresponding to each topic from the reference data set through the AI model; and generating a questionnaire response report based on the response content through the AI model and providing the questionnaire response report to a website.

### CROSS-REFERENCE TO RELATED APPLICATION

This application claims the priority benefit of Taiwan application serial no. 112142238, filed on Nov. 2, 2023. The entirety of the above-mentioned patent application is hereby incorporated by reference herein and made a part of this specification.

### BACKGROUND

### Technical Field

The present disclosure relates to an artificial intelligence technology, and in particular to a method of automatically generating a report and an electronic device thereof.

### Description of Related Art

As there is an increasing attention to the sustainable development agenda worldwide, more focuses have been laid on environmental, social, and corporate governance (ESG) issues, and now more companies begin to recognize the importance of making positive progress on ESG performance, and begin to take into account corporate social responsibility to meet the requirements of investors, regulators and stakeholders. Therefore, ESG-related questionnaires and sustainability reports are current the important tools for assessing corporate sustainability performance and social impact.

However, effectively preparing ESG reports and responding to world-ranked questionnaire topics is a complex task. In addition to collection of a large amount of data, analysis and sorting, it is also necessary to ensure that the information provided is accurate, reliable and credible. Moreover, ESG-related issues normally involve a variety of topics, such as carbon emissions, community participation, and corporate governance. For companies, preparing ESG reports or answering ESG-related topics is often time-consuming and requires a large amount of human resources, and the result might be influenced by subjective factors.

### SUMMARY

The present disclosure provides a method for automatically generating reports and an electronic device thereof, which helps to improve the objectivity of questionnaire response reports.

In the disclosure, a method for automatically generating a report is adaptable to be realized by using an electronic device. The method includes: converting a questionnaire file through an artificial intelligence (AI) model to obtain a topic data set, wherein the topic data set includes multiple topics identified from the questionnaire file; performing text analysis on historical document data through a first deep learning model to filter out a reference data set that matches the topic data set from the historical document data; obtaining response content corresponding to each topic from the reference data set through the AI model; and generating a questionnaire response report based on the response content through the AI model and providing the questionnaire response report to a website.

The electronic device for automatically generating reports of the present disclosure includes: a communication interface disposed to receive a historical document data and a questionnaire file; a memory including an AI model and a first deep learning model; and a processor coupled to a communication interface and the memory, and disposed to: convert a questionnaire file through the AI model to obtain a topic data set, wherein the topic data set includes multiple topics identified from the questionnaire file; perform text analysis on the historical document data through the first deep learning model to filter out a reference data set that matches the topic data set from the historical document data; obtain response content corresponding to each topic from the reference data set through the AI model; and generate a questionnaire response report based on the response content through the AI model and provide the questionnaire response report to a website.

Based on the above, this disclosure automatically generates a questionnaire response report through historical document data and questionnaire files, which not only may reduce the workload of practitioners, reduce the risk of human error, but also improve the objectivity of the report.

### BRIEF DESCRIPTION OF THE DRAWINGS

FIG. 1 is a schematic diagram of automatically generating a report using generative AI technology according to an embodiment of the present disclosure.

FIG. 2 is a block diagram of an electronic device that automatically generates reports according to an embodiment of the present disclosure.

FIG. 3 is a flow chart of a method for automatically generating a report according to an embodiment of the present disclosure.

FIG. 4 is a schematic diagram of a multiple-choice question according to an embodiment of the present disclosure.

FIG. 5A is a schematic diagram of hierarchical generative results based on the result of the first deep learning model according to an embodiment of the present disclosure.

FIG. 5B is a schematic diagram of hierarchical generative results based on the result of the second deep learning model according to an embodiment of the present disclosure.

FIG. 6 is a schematic diagram of hierarchical generative results based on the integration result of two deep learning models according to an embodiment of the present disclosure.

FIG. 7 is a schematic diagram of a multiple-choice question according to an embodiment of the present disclosure.

FIG. 8 is a schematic diagram of a generative result according to an embodiment of the present disclosure.

### DESCRIPTION OF THE EMBODIMENTS

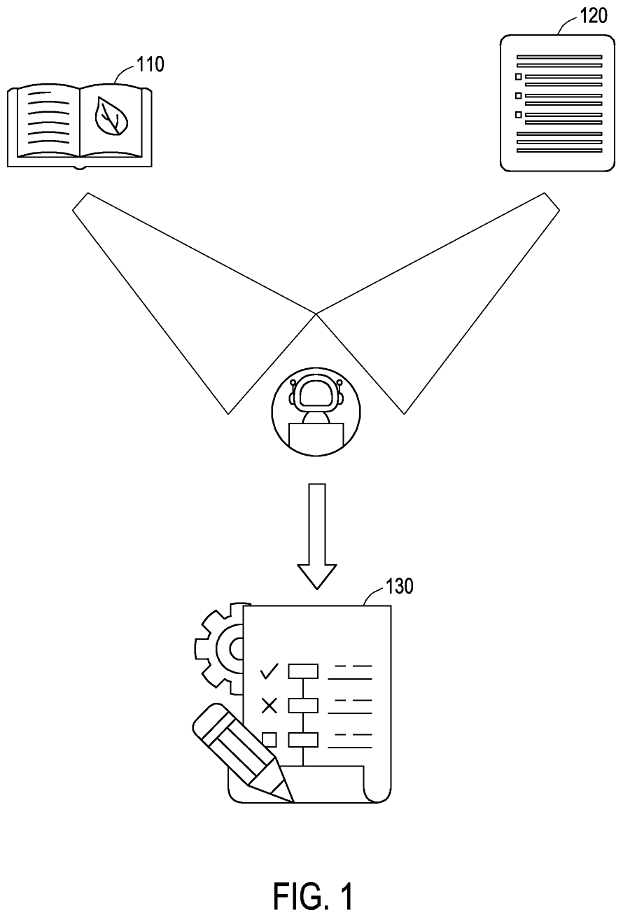

FIG. 1 is a schematic diagram of automatically generating a report using generative artificial intelligence (generative AI) technology according to an embodiment of the present disclosure. By using the generative AI technology, a questionnaire response report 130 is generated based on the historical document data 110 provided by the user and the topics on the questionnaire file 120. The generative AI technology obtains the most appropriate answers from the historical document data 110 based on the topics on the questionnaire file 120, and generates the questionnaire response report 130 accordingly. In this way, it is not only possible to save time but also ensure appropriateness and consistency of answers. In an embodiment, the historical document data 110 is, for example, at least one of a sustainability report, a company's annual report, and the like. The questionnaire file 120 is, for example, a Dow Jones Sustainability Indices (DJSI) questionnaire file.

On ESG issues, the generative AI technology is able to automatically generate text content that conforms to semantics and grammar to solve the above challenges related to ESG, thereby enhancing the quality and efficiency of sustainability reports and questionnaire responses. By using the generative AI technology, it is easier to process large amounts of ESG data (i.e., historical document data 110) and generate reports and summaries with significant information to help companies and investors better understand and analyze relevant data. In the meantime, it is also possible to assist companies to use more objective, professional and standard-compliant language when writing ESG reports (i.e., questionnaire response reports 130) to enhance the transparency and credibility of the reports. By helping companies automatically generate accurate and reliable ESG reports, efficiency and accuracy of reports may be improved. Secondly, when conducting ESG-related questionnaires, the generative AI technology may help participants answer topics more accurately and provide more in-depth and insightful responses, thereby improving the effectiveness and value of the questionnaire.

In addition, the generative AI technology may further help companies discover important information that is not disclosed in the historical document data 110, so as to better formulate remedial plans or improve the quality of next year's report content. Examples are listed below for explanation.

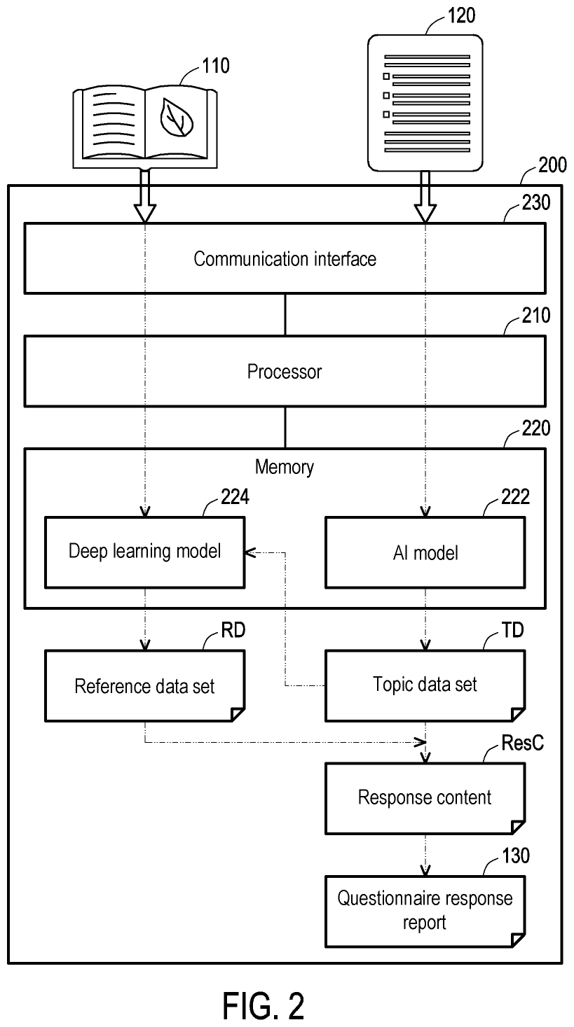

FIG. 2 is a block diagram of an electronic device that automatically generates reports according to an embodiment of the present disclosure. Referring to FIG. 2, the electronic device 200 includes a processor 210, a memory 220 and a communication interface 230. The processor 210 is coupled to the memory 220 and the communication interface 230.

The processor 210 is, for example, a central processing unit (CPU), a physical processing unit (PPU), a programmable microprocessor, an embedded control chip, a digital signal processor (DSP), an Application Specific Integrated Circuit (ASIC) or other similar devices.

The memory 220 is, for example, any type of fixed or removable random access memory (RAM), a read-only memory (ROM), a flash memory, a hard disk drive or other similar device or a combination of these devices. The memory 220 includes an AI model 222 and a deep learning model 224. The processor 210 executes the method of automatically generating a report through the AI model 222 and the deep learning model 224.

The communication interface 230 is disposed to receive the historical document data 110 and the questionnaire file 120 provided by the user. For example, the communication interface 230 may adopt a Universal Serial Bus (USB) port, a General Purpose Interface Bus (GPIB) port, or a Local Area Network (LAN) port and so on to receive or transmit data.

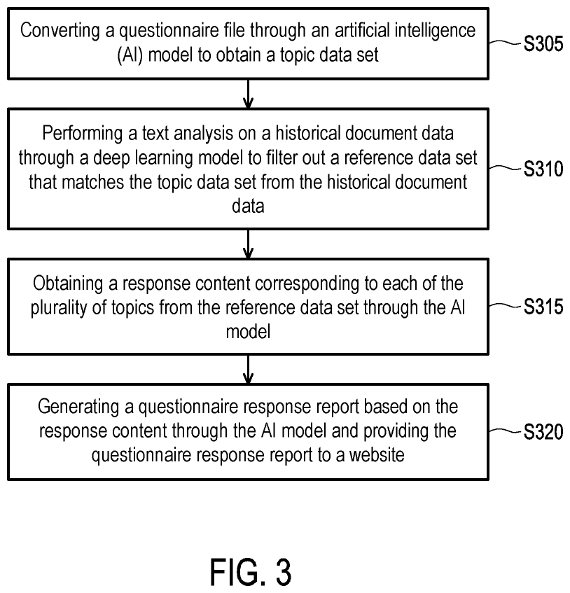

FIG. 3 is a flow chart of a method for automatically generating a report according to an embodiment of the present disclosure. Please refer to FIG. 1 to FIG. 3. In step S305, the questionnaire file 120 is converted through the AI model 222 to obtain the topic data set TD. Here, the topic data set TD includes a plurality of topics identified from the questionnaire file 120. For example, the processor 210 will first use a specific package to automatically sort major topics and details thereof in the questionnaire file 120, and provide the major topics and details thereof to the AI model 222 one by one. Afterwards, the processor 210 converts the divided content into text files through the AI model 222.

In an embodiment, the questionnaire file 120 is a DJSI questionnaire file, and the format thereof is portable document format (PDF). In this case, for example, the pypdf package in Python is adopted to parse the questionnaire file 120 and obtain the content in the questionnaire file 120, and then define regular expressions to match the paragraph ranges of each major topic, thereby automatically sorting detailed items required to be described under each major topic.

Next, these detailed items are used as input sources to the AI model 222, and with the designed refined command set, conversion of topics may be completed. The refined command set includes commands to define the role to be played, commands to define the task to be performed, commands to define background information related to the task, and commands to define output style. For example, the refined command set includes “[role], [task], [background information], [style]”.

For example, if you want to complete a report related to Task Force on Climate-related Financial Disclosures (TCFD), the refined command set may be designed as follows: “[Assume you are an expert who is very familiar with TCFD affairs], [Please analyze the details required to be stated in the key points stipulated in international standards, and provide three topics that the company must answer for this detail], [The following is the detailed content of the required description: {provide the detailed items required to be described under each major topic and automatically sorted by pypdf}], [Please ensure that the questions provided fully take into consideration the questionnaire topics, and ensure that the questions provided are professional and non-repetitive]”. By analogy, the above refined command set may be changed based on what topic the user currently wants to write a report on. For example, the “TCFD affair” in the “role”-related commands may be changed to any topic. In another example, “three” in the commands related to the “task” may be changed freely to meet the user's needs.

In addition, in order to complete an ESG report, the refined command set may be designed as follows: “[Assume that you are an expert who knows the ESG DJSI very well], [Please analyze the questionnaire topic of DJSI, provide the questions that the company must answer as requested in the topic], [The following is the questionnaire topic: {Provide the topic number and topics automatically sorted by pypdf}], [Please ensure that the questions provided fully take into consideration the questionnaire topics, and ensure that the questions provided are professional and non-repetitive]”.

The AI model 222 completes the conversion of topics according to the refined command set, and finally generates text content (i.e., topic data set TD). Compared with directly providing a lot of narrative content to the AI model 222 to generate text content, a refined command set is adopted first to convert the topics, so that the generative results of the AI model 222 are more detailed and specific, and will not be too general.

In step S310, the deep learning model 224 is adopted to perform text analysis on the historical document data 110 to filter out the reference data set RD that matches the topic data set TD in the historical document data 110. The deep learning model 224 selects reference data matching each topic in the topic data set TD from multiple contents included in the historical document data 110, wherein the reference data set includes reference data related to each topic.

The electronic device 200 may be further disposed to: if the deep learning model 224 determines that there is no reference data matching one of the specific topics among the multiple contents included in the historical document data 110, the processor 210 issues a document-supplementing suggestion to obtain a reference data matching a specific topic from another reference document data.

In order to ensure that the subsequent response content of the AI model 222 is closely related to the company's information, and to avoid that the training data of the AI model 222 is out of date, text analysis is performed on the historical document data 110 by the deep learning model 224 to solve the common problems listed above. Specifically, assuming that the style of the historical document data 110 is PDF, after the user uploads/provides the relevant historical document data 110 (the latest document or data) to the electronic device 200, the processor 110 may also first use the pypdf package in Python to obtain numerous contents in the historical document data 110, then use the deep learning model 224 to filter out the text content that is highly matched with each topic in the topic data set TD from the numerous contents as reference data, and then combines the multiple reference data sets into a reference data set RD.

The deep learning model 224 uses a similarity calculation method (such as cosine similarity) to compare the similarity between the content of the historical document data 110 and the refined topics, thereby finding the reference data that is highly matched with each top from the historical document data 110 and add the reference data to the reference data set RD.

In another embodiment, two or more deep learning models 224 may also be used to filter out the reference data set RD. For example, the first deep learning model and the second deep learning model are adopted to perform text analysis on the historical document data 110 respectively. For example, the CrossEncoder model and the multilingual BERT model may be adopted to implement the first deep learning model and the second deep learning model respectively. The CrossEncoder model selects reference data that match each topic in the historical document data 110, and the multilingual BERT model selects another reference data that matches each topic in the historical document data 110. Thereafter, the above two reference data will then be used as the final reference data set RD provided to the AI model 225.

In step S315, the response content ResC corresponding to each topic is obtained from the reference data set RD through the AI model 222. After filtering out the reference data set RD that is highly matched with each topic of the topic data set TD from the historical document data 110 through text analysis, the reference data set RD is used as an input source and provided to the AI model 222. Such a design may remedy the issue that the AI model 222 does not use historical document data 110 (for example, company-related information or the latest information) during the training phase.

In an embodiment, the AI model 222 obtains the response content ResC based on the reference data set RD and the refined topic data set TD combined with the first-level command set. The design of the first-level command set may also be defined as “[role], [task], [background information], [style]” as shown in the above-mentioned refined command set. For example, to complete a report related to TCFD, the first-level command set may be designed as follows: “[Assuming that you are an expert who knows TCFD affairs very well], [Please respond to the refined topics thoroughly according to the text provided below], [The following is highly relevant content: {Provide highly matched content found using deep learning models}; The following is the refined topic: {Provide topic conversion results generated using AI models}], [Please ensure that the content of the response takes into account the highly relevant content provided, and try to answer the refined questions requested as much as possible, and ensure that the content of the response is like a professional article]”. In the above commands, “highly matched content found using deep learning models” is the reference data set RD, and “topic conversion results generated using AI models” is the topic in the topic data set TD.

Furthermore, the AI model 222 may also decide to use only the first-level command set or use the first-level command set and the second-level command set based on multiple-choice questions (questions with options to be selected) or non multiple-choice questions (questions with no options to be selected).

Specifically, the AI model 222 will first use the first-level command set to retrieve relevant data corresponding to each topic from the reference data set RF. For the non multiple-choice questions in the topic data set, the AI model 222 directly uses the relevant data as the response content ResC. In addition, for each multiple-choice question in the topic data set, the AI model 222 will use the second-level command set to determine a recommended option among the multiple candidate options included in each multiple-choice question based on relevant data, and combine the relevant data with the recommended option as response content ResC.

In order to ensure that the generation of the questionnaire response report 130 allows users to perform verification quickly and thereby improve their trust in the recommendation results of the AI model 222, when generating the questionnaire response report 130, a multi-level command set (such as the first-level command set and second-level command set) may be adopted to ensure that the generated results meet the requirements.

For example, to complete an ESG report, the first-level command set may be designed as follows: “[Assuming that you are an expert who knows the ESG DJSI very well], [Please respond to the refined topics thoroughly according to the text provided below], [The following is highly relevant content: {Provide content filtered out by deep learning models}; The following is the refined topic: {Provide topic conversion results generated using AI models}], [Please ensure that the content of the response takes into account the highly relevant content provided, and try to provide relevant data as supporting evidence]”. In the above commands, “content filtered out by deep learning models” is the reference data set RD, and “topic conversion results generated using AI models” is the topic in the topic data set TD.

The second-level command set may be designed as follows: “[Assuming that you are an expert who knows the ESG DJSI very well], [Please recommend the most suitable option for the multiple-choice questions provided subsequently based on the information provided below], [The following is the relevant information: {Provide the results of the first-level command set}], [Please ensure that the response content explains the reason for the recommendation and which page of information is cited]”. In the above commands, the “result of the first-level command set” refers to relevant data corresponding to the topic obtained from the reference data set RD by using the first-level command set.

In addition, the AI model 222 may be further designed to retrieve the location index (such as page number) of the relevant data in the historical document data 110 when retrieving the relevant data, and add the location index to the response content ResC. For example, when using the deep learning model 224 to extract content that is highly relevant to each topic in the refined topic data set TD, the deep learning model 224 will further capture its location index (such as page number on the PDF document) in the historical document data 110. The deep learning model 224, while acquiring highly relevant content, also cites the file name and location index of the historical document data 110 as the reference data set RD. The reference data set RD is used as the input source of the AI model 222. The AI model 222 uses the first-level command set to provide relevant data that can answer the question of the topic based on the filtered highly relevant content. Then, the relevant data obtained by the first-level command is set as the input source of the AI model 222, and let the AI model 222 explain, based on the relevant data, which candidate option in the multiple-choice question will be recommended and the reason therefor if the original topic (the corresponding topic number and topic automatically obtained from the historical document data 110 at the beginning) is to be answered.

In step S320, the questionnaire response report 130 is generated based on the response content ResC through the AI model 222, and the questionnaire response report 130 is provided to the website. The questionnaire response report 130 finally displayed to the user is composed of the relevant information obtained by the first-level command set and the recommended options and explanation (supporting data) obtained by the second-level command set. Moreover, relevant page numbers may be further added to the questionnaire response report 130. Through such a design, the user may perform check quickly in the historical document data 110 according to the indicated page number, and speed up the answering process of the questionnaire through the explanation given by the AI model 222.

In addition, the AI model 222 may be further designed to: give a score value according to the order of each candidate option for multiple candidate options included in each multiple-choice question. After deciding on the recommended option, if the score value of the recommended option does not reach the specified score, the AI model 222 issues a document-supplementing suggestion for the specified topic corresponding to the recommended option. For example, it is set so that the score value of the candidate options that are closer to the topic is higher, and the score value of the candidate options that are further away from the topic is lower. If the recommended option is not the option with the high score or the second-highest score, a document-supplementing suggestion is issued. Or if the recommended option is the option with the lowest score or the second-lowest score, a document-supplementing suggestion is issued.

After receiving the document-supplementing suggestion, the user may further provide other data files to the electronic device 200, so that the processor 210 retrieves the new disclosure content corresponding to the specified topic through the deep learning model 224 again, and provide the new disclosure content to the website. Moreover, after receiving the data file corresponding to the document-supplementing suggestion, the processor 210 may also use the deep learning model 224 to re-filter out the new disclosure content that matches the specified topic from the provided data file, and then use the AI model 222 to re-determine recommended options among multiple candidate options included in the specified topic based on the new disclosure content. For example, the AI model 222 uses the first-level command set to find relevant data corresponding to the specified topic in the new disclosure content, and then uses the second-level command set to re-select another one option from the multiple candidate options included in the specified topic as the recommended option based on the relevant data, and combine the relevant data and the recommended option as the response content ResC.

Assuming that the questionnaire file 120 is divided into N questions in accordance with the key points stipulated in international standards, the text analysis performed by the deep learning model 224 and the process of topic conversion and response content generation performed by the AI model 222 will be repeated N times. In the meantime, by recording the output results of each generated response content, a version of the questionnaire response report 130 may be generated quickly.

In an application example, the historical document data 110 may include multiple documents, and the processor 210 may automatically perform text analysis on each document and generate a questionnaire response report 130 accordingly. Assuming that the historical document data 110 includes five documents, the processor 210 may quickly generate a corresponding questionnaire response report 130 for each document, and finally obtain five questionnaire response reports 130 corresponding to the five documents.

In addition, the related content under the same topic may also be used as input sources through the AI model 222, so that the AI model 222 describes the contents of all five documents in a highly consistent narrative style while maximizing content diversity and avoiding repeated descriptions of content. Here, the AI model 222 may be equipped with a design command set “[role], [task], [background information], [style]”, for example, “[Assuming you are an expert who knows TCFD affairs very well], [Please integrate the content based on the content provided below], [For the content under the same topic below: Provide content generated by five documents using AI models], [Please ensure that the integrated content only takes into account the provided content, and ensure the integrated result is like a professional article using consistent terminology and tone]”. The AI model 222 equipped with the above design command set will be able to obtain the output of the integrated five documents.

Providing abundant input sources to the AI model 222 is of great influence on the output quality of the AI model 222. In addition to generating and integrating content for different documents on the same topic, not only that the breadth of the content may be improved, but also it is possible to quickly help users filter out which documents are helpful for which topics. Moreover, multiple different versions of the questionnaire response reports 130 may also be generated for the same document by using different topics, and then the multiple questionnaire response reports 130 may be integrated to enhance the depth of the content.

Through the randomness of the AI model 222, by repeating the process of topic conversion multiple times, and the results of each conversion are subjected to text analysis and the process of generating response content, it is also possible to quickly generate multiple versions of the questionnaire response report 130. Similarly, by specifying the relevant integration command set, the output of content integration carried out by using the AI model 222 may be obtained. Therefore, by integrating the respective analysis results of different documents and integrating the respective analysis results of different topics, it is feasible to solve the problem encountered by most users, that is, the AI model 222 can only quickly generate report content but the content quality is poor.

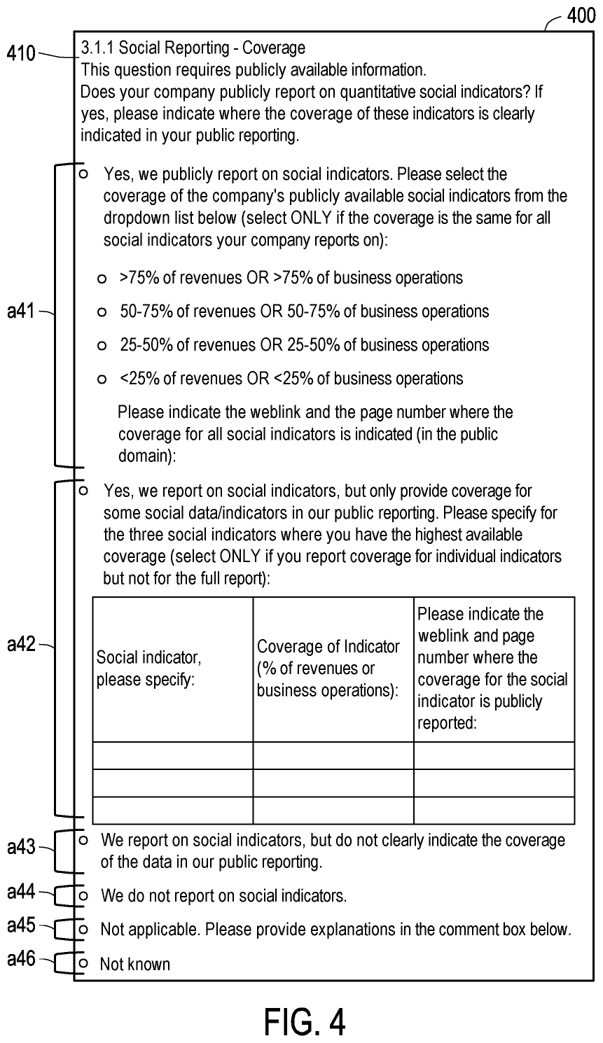

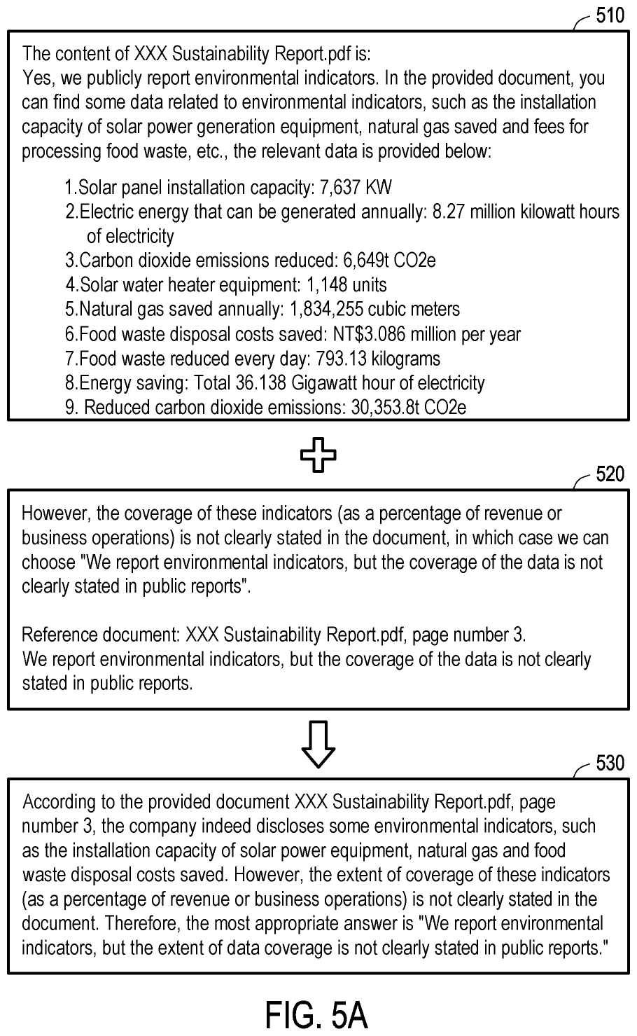

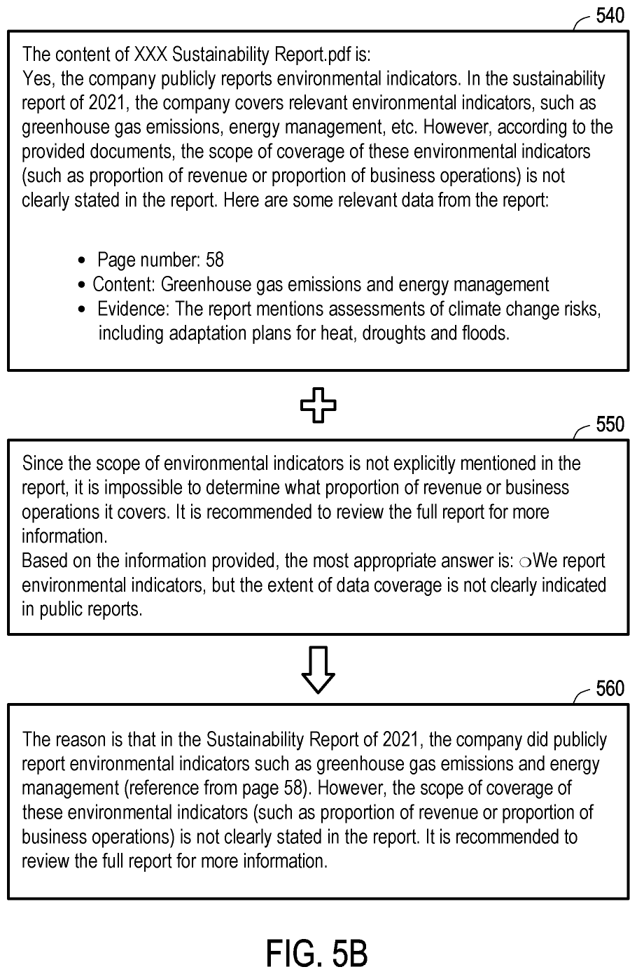

In the first application example below, the AI model 222 obtains the response content corresponding to the topic based on the two results obtained by performing text analysis on the historical document data 110 using two deep learning models. The first application example is described below with reference to FIG. 4, FIG. 5A and FIG. 5B.

FIG. 4 is a schematic diagram of a multiple-choice question according to an embodiment of the present disclosure. FIG. 5A is a schematic diagram of hierarchical generative results based on the result of the first deep learning model according to an embodiment of the present disclosure. FIG. 5B is a schematic diagram of hierarchical generative results based on the result of the second deep learning model according to an embodiment of the present disclosure. In the first application example, the topic 410 in the questionnaire file 400 in FIG. 4 is a multiple-choice question with multiple candidate options a41 to a46. Here, it is assumed that the first deep learning model is the CrossEncoder model, and the second deep learning model is the multilingual BERT model. FIG. 5A shows the hierarchical generative results obtained for the first reference data matching topic 410 filtered out by the CrossEncoder model. FIG. 5B shows the hierarchical generative results obtained for the second reference data matching topic 410 filtered out by the multilingual BERT model.

Referring to FIG. 5A, the AI model 222 uses the first-level command set to obtain relevant data 510 that matches the topic 410 from the first reference data filtered out by the CrossEncoder model. Afterwards, the AI model 222 uses a second-level command set to obtain recommended content 520 based on the relevant data 510. Here, the AI model 222 selects the candidate option a43 as the recommended option. Afterwards, the AI model 222 generates the response content 530 based on relevant data 510 and recommended content 520.

Referring to FIG. 5B, the AI model 222 uses the first-level command set to obtain relevant data 540 that matches the topic 410 from the second reference data filtered out by the multilingual BERT model. Afterwards, the AI model 222 uses a second-level command set to obtain recommended content 550 based on the relevant data 540. Here, the AI model 222 selects the candidate option a43 as the recommended option. Afterwards, the AI model 222 generates the response content 560 based on relevant data 540 and recommended content 550.

It can be seen from FIG. 5A and FIG. 5B that even if the same historical document data 110 is used and different deep learning models are used, the response content 560 finally generated by the AI model 222 will not be exactly the same.

In the first application example, it is assumed that candidate option a41 has the highest score, the candidate option a42 has the second highest score, and so on, and the candidate option a45 has the lowest score. Therefore, the candidate option a43 recommended by the AI model 222 is not the candidate option that can get the highest score, which means that the historical document data 110 currently provided still has not achieved all of the disclosed matters. Accordingly, the processor 210 may issue document-supplementing suggestions, for example, display relevant prompts on the display, so that the user is able to understand which recommended options for the topics are not the highest-scoring options. The candidate option which does not have the high score as the recommended option represent that there is still room for improvement, and users should quickly formulate relevant strategies and take actions to quickly produce new disclosure content and publish the same on the website in a short period of time. In the long term, it is also possible to add the overlooked parts to future questionnaire response reports to improve the quality of the questionnaire response reports.

For example, the AI model 222 is used to answer the same topic using external data or documents from other competing companies, and quickly find out which company has the best performance in answering the topic. In addition, since the response content may include the file name and location index (page number), the response content may be readily adopted as a draft and combined with the relevant data indicators of one's own company to be modified by the AI model 222, thereby producing new disclosure content, and the disclosure content may be quickly published on the website for supplementary, or added to the future questionnaire response reports.

When encountering with topics that fail to obtain the highest score as the recommended option, the AI model 222 is able to provide valuable suggestions. For example, the AI model 222 will suggests what needs to be added to make the answer more complete. Specifically, two approaches may be offered to supplement this evidence. The first approach is: based on the suggested content, if the user has any ideas, the user may provide relevant indicator data and let the AI model 222 generate new disclosure content based on these indicators for publication on the website or as material for a report of the next issue. In this way, it is possible to help users continuously improve the substantiality of information and reduce the risk of poor evaluation results. The second approach is to refer to content from other companies that received the highest scores on the same topic. For example, users may compare the performance of different companies' sustainability reports on the same topic to find out which company's report content is likely to get the highest score. Because the AI model 222 will show the page on which this content is disclosed in the report, after using the content of this page as a draft, combined with the indicator data related to the company provided by the user, the relevant data in the draft may be replaced and new disclosure content will be generated for publication on the website or as the material for a report of the next issue. In this way, it is possible to ensure that the answers that respond to the questionnaire file subsequently will be more competitive because the answers draws on the successful practices of peer companies.

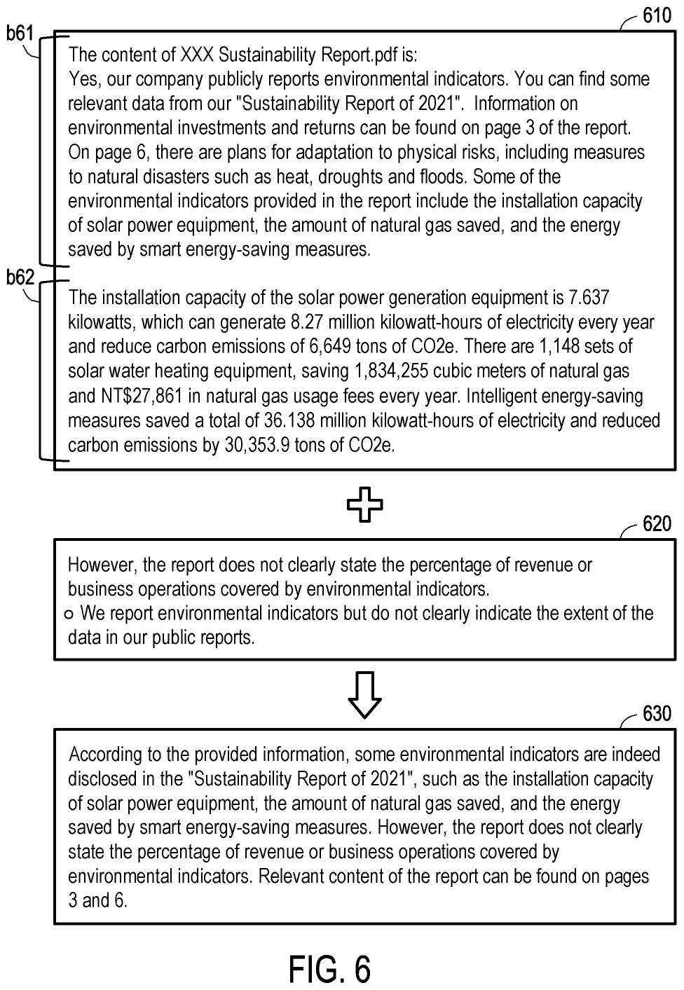

FIG. 6 is a schematic diagram of hierarchical generative results based on the integration result of two deep learning models according to an embodiment of the present disclosure. Here, it is assumed that this embodiment is directed to topic 410 in FIG. 4, and assumes that the CrossEncoder model and the multilingual BERT model are used. In this embodiment, the AI model 222 uses the first-level command set to obtain the data b61 and data b62 matching the topic 410 from the reference content obtained by the CrossEncoder model and the reference content obtained by the multilingual BERT model respectively. Afterwards, the AI model 222 uses the second-level command set to obtain the recommended content 620 based on the integration result 610 of the relevant data b61 and the relevant data b62. Afterwards, the AI model 222 generates response content 630 based on the integration result 610 and the recommended content 620.

By using multiple deep learning models, more diverse and highly relevant content may be collected, so that the input sources provided to the AI model 222 are more abundant, and the AI model 222 may be more fully informed when explaining relevant supporting information. In this manner, not only that the rationality of content may be improved, but also the inconsistency in answers may be reduced.

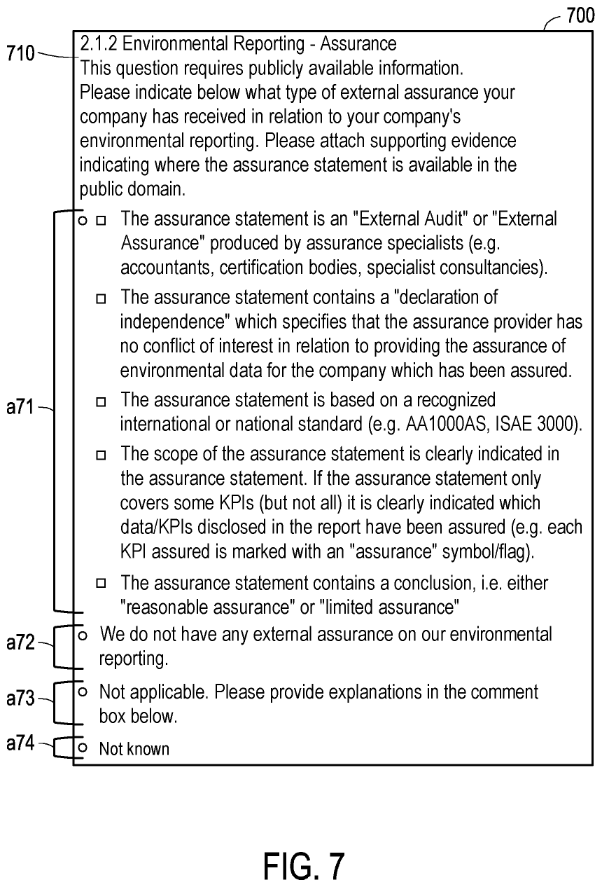

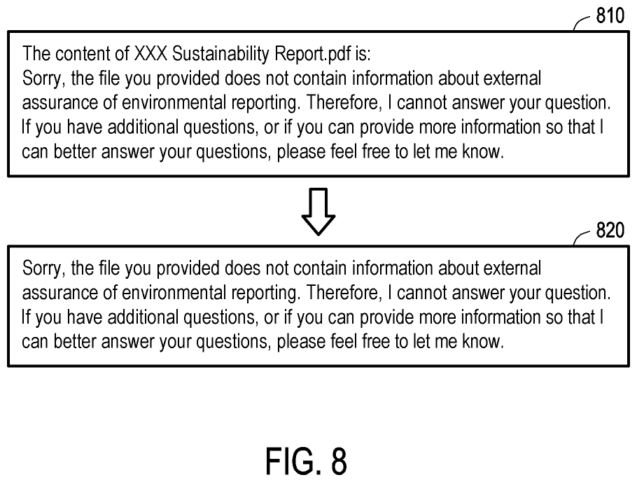

In addition, due to the randomness of the AI model 222, irrational responses may sometimes be generated. By providing accurate and highly relevant content (reference data set RD) to the AI model 222, if the historical document data 110 and the specified topic of the topic data set TD do not have highly similar content, the AI model 222 may be further designed to re-issue a document-supplementing suggestion to honestly state that there is no relevant content in the historical document data 110 to answer this topic, so as for the user to provide other relevant files to improve the response content. The following is a second application example for explanation. The second application example will be described with reference to FIG. 7 and FIG. 8.

FIG. 7 is a schematic diagram of a multiple-choice question according to an embodiment of the present disclosure. FIG. 8 is a schematic diagram of a generative result according to an embodiment of the present disclosure. In the first application example, the topic 710 in the questionnaire file 700 in FIG. 7 is a multiple-choice question with multiple candidate options a71 to a74. FIG. 8 shows the response content 810 of the AI model 222 and the document-supplementing suggestion 820. The user may provide other relevant documents through the document-supplementing suggestion 820 for the processor 210 to execute the deep learning model 224 and the AI model 222 to re-generate the response content.

In order to ensure that the AI model 222 does not create false information and ensure the reliability of the generative results of the AI model 222, questions unrelated to user-provided documents were used in the testing phase to test the responses of the AI model 222. After repeated tests, the AI model 222 was able to honestly describe that there was no relevant information in the provided document to answer the specified topic, and suggested that the user provide other documents to improve the answer. After testing, the reliability of the answers generated by the AI model 222 was ensured, and it was verified that the AI model 222 has the ability to quickly filter out relevant documents.

In summary, the present disclosure may reduce the workload of practitioners and reduce the risk of human error through generative AI technology. In the meantime, because the generated content is based on a large amount of data and empirical information, this technology also helps to enhance the objectivity of the report, allowing the application of generative AI technology in the ESG field to implement ESG business in a more transparent, sustainable and reliable manner.

Users may quickly and automatically generate a questionnaire response report using the above implementation method only by providing historical documents or original data as well as specific guidelines. This disclosure not only improves the speed but also has diverse functions. For example, after using this disclosure, users may easily turn an ESG sustainability report into a TCFD report by simply inputting the TCFD guideline framework recognized by international standards. In addition to setting the questions that the user wants to ask in the refinement guide framework in the tool, relevant background information may also be captured from the provided documents to create a questionnaire response report.

By using generative AI technology, it is possible to automatically generate text content that conforms to semantics and grammar to solve the above challenges related to ESG, thereby enhancing the quality and efficiency of sustainability reports and questionnaire responses. First of all, by using the generative AI technology, it is easier to process large amounts of ESG data and generate reports and summaries with significant information to help companies and investors better understand and analyze relevant data. In the meantime, it is also possible to assist companies to use more objective, professional and standard-compliant language when writing ESG reports to enhance the transparency and credibility of the reports. By helping companies automatically generate accurate and reliable ESG reports, efficiency and accuracy of reports may be improved. Secondly, when conducting ESG-related questionnaires, the generative AI technology may help participants answer topics more accurately and provide more in-depth and insightful responses, thereby improving the effectiveness and value of the questionnaire. Also, generative AI technology may also help companies discover important information that is not disclosed in ESG, so as to better formulate remediation plans or improve the quality of report content for the next year.

Furthermore, this disclosure may automatically generate different levels of topics when refining the guideline framework by processing the same ESG sustainability report, thus ensuring the diversity and depth of the topics. This disclosure may also be changed to deal with different ESG sustainability reports, and no longer just refer to previous reports of one's own company, but also actively refer to the sustainability reports of other companies of similar nature. This disclosure may be used in discovering differences, so that the user may more easily discover potential room for improvement, and then consider the strengths of other companies and make up for the blind spots overlooked by the user's own company, which may also help improve the quality of reports. This disclosure is not only for generating reports automatically, but also a comprehensive value-added tool that help users continuously improve ESG performance, thereby enhancing corporate reputation and meeting investor expectations.

What is claimed is:

1. A method for automatically generating a report adaptable to be realized by using an electronic device, the method comprising:
converting a questionnaire file through an artificial intelligence (AI) model to obtain a topic data set, wherein the topic data set comprises a plurality of topics identified from the questionnaire file;
performing a text analysis on a historical document data through a first deep learning model to filter out a reference data set that matches the topic data set from the historical document data;
obtaining a response content corresponding to each of the plurality of topics from the reference data set through the AI model; and
generating a questionnaire response report based on the response content through the AI model and providing the questionnaire response report to a website.

2. The method for automatically generating the report according to claim 1, wherein obtaining the response content corresponding to each of the plurality of topics from the reference data set through the AI model comprises:
retrieving a relevant data corresponding to each of the plurality of topics from the reference data set;
for each multiple-choice question in the plurality of topics, determining a recommended option among a plurality of candidate options comprised in each of the multiple-choice questions based on the relevant data, and combining the relevant data with the recommended option as the response content; and
for each non multiple-choice question in the plurality of topics, using the relevant data directly as the response content.

3. The method for automatically generating the report according to claim 2, wherein retrieving the relevant data corresponding to each of the plurality of topics from the reference data set further comprises:
retrieving a location index of the relevant data in the historical document data, and adding the location index to the response content.

4. The method for automatically generating the report according to claim 2, wherein an order of the plurality of candidate options comprised in each of the multiple-choice questions represents a score value;
wherein, after determining the recommended option, the method further comprises:
issuing a document-supplementing suggestion for a specified topic corresponding to the recommended option if the score value of the recommended option does not reach a specified value.

5. The method for automatically generating the report according to claim 4, wherein, after issuing the document-supplementing suggestion, the method further comprises:
in response to receiving a data file corresponding to the document-supplementing suggestion, using the deep learning model to retrieve a new disclosure content corresponding to the specified topic from the data file; and
providing the new disclosure content to the website.

6. The method for automatically generating the report according to claim 5, further comprising:
after retrieving the new disclosure content corresponding to the specified topic, re-determining the recommended option among the plurality of candidate options comprised in the specified topic by the AI model based on the new disclosure content, and combining the new disclosure content with the recommended option as the response content.

7. The method for automatically generating the report according to claim 1, wherein performing the text analysis on the historical document data through the first deep learning model to filter out the reference data set that matches the topic data set from the historical document data comprises:
filtering out a reference data matching each of the plurality of topics from a plurality of contents comprised in the historical document data, wherein the reference data set comprises the reference data for each of the plurality of topics; and
in the event that the reference data that matches a specific topic of the plurality of topics does not exist in the content comprises in the historical document data, issuing a document-supplementing suggestion to obtain the reference data that matches the specific topic from another reference document data.

8. The method for automatically generating the report according to claim 1, wherein converting the questionnaire file through the AI model to obtain the topic data set comprises:
converting the questionnaire file through the AI model based on a refined command set, wherein the refined command set comprises a command for defining a role, a command for defining a task, a command for defining a background information, and a command for defining an output style.

9. The method for automatically generating the report according to claim 1, further comprising:
using a second deep learning model to perform the text analysis on the historical document data to filter out another reference data set matching the topic data set in the historical document data for the AI model to obtain the response content corresponding to each of the plurality of topics from the reference data set and the another reference data set.

10. The method for automatically generating the report according to claim 1, wherein the historical document data comprises at least one of a sustainability report and an annual report,
the questionnaire file is a Dow Jones Sustainability Indices (DJSI) questionnaire file.

11. An electronic device for automatically generating a report, comprising:
a communication interface disposed to receive a historical document data and a questionnaire file;
a memory comprising an AI model and a first deep learning model; and
a processor coupled to the communication interface and the memory, and disposed to:
convert the questionnaire file through the AI model to obtain a topic data set, wherein the topic data set comprises a plurality of topics identified from the questionnaire file;
perform a text analysis on the historical document data through the first deep learning model to filter out a reference data set that matches the topic data set from the historical document data;
obtain a response content corresponding to each of the plurality of topics from the reference data set through the AI model; and
generate a questionnaire response report based on the response content through the AI model and provide the questionnaire response report to a website.

12. The electronic device according to claim 11, wherein the processor executes the AI model to:
retrieve a relevant data corresponding to each of the plurality of topics from the reference data set;
for each multiple-choice question in the plurality of topics, determine a recommended option among a plurality of candidate options comprised in each of the multiple-choice questions based on the relevant data, and combine the relevant data with the recommended option as the response content; and
for each non multiple-choice question in the plurality of topics, use the relevant data directly as the response content.

13. The electronic device according to claim 12, wherein the processor executes the AI model to:
retrieve a location index of the relevant data in the historical document data, and add the location index to the response content.

14. The electronic device according to claim 12, wherein an order of the plurality of candidate options comprised in each of the multiple-choice questions represents a score value, and the processor executes the AI model to:
after determining the recommended option, issue a document-supplementing suggestion for a specified topic corresponding to the recommended option if the score value of the recommended option does not reach a specified value.

15. The electronic device according to claim 14, wherein the processor is disposed to:
in response to receiving a data file corresponding to the document-supplementing suggestion, use the deep learning model to retrieve a new disclosure content corresponding to the specified topic from the data file; and
provide the new disclosure content to the website.

16. The electronic device according to claim 15, wherein the processor is disposed to:
after retrieving the new disclosure content corresponding to the specified topic, re-determine the recommended option among the plurality of candidate options comprised in the specified topic by the AI model based on the new disclosure content, and combine the new disclosure content with the recommended option as the response content.

17. The electronic device according to claim 11, wherein the processor executes the first deep learning model to:
filter out a reference data matching each of the plurality of topics from a plurality of contents comprised in the historical document data, wherein the reference data set comprises the reference data for each of the plurality of topics; and
in the event that the reference data that matches a specific topic of the plurality of topics does not exist in the content comprises in the historical document data, issue a document-supplementing suggestion to obtain the reference data that matches the specific topic from another reference document data.

18. The electronic device according to claim 11, wherein the processor executes the AI model to:
convert the questionnaire file based on a refined command set, wherein the refined command set comprises a command for defining a role, a command for defining a task, a command for defining a background information, and a command for defining an output style.

19. The electronic device according to claim 11, wherein the memory further comprises a second deep learning model, and the processor executes the second deep learning model to:
perform the text analysis on the historical document data to filter out another reference data set matching the topic data set in the historical document data for the AI model to obtain the response content corresponding to each of the plurality of topics from the reference data set and the another reference data set.

20. The electronic device according to claim 11, wherein the historical document data comprises at least one of a sustainability report and an annual report,
the questionnaire file is a Dow Jones Sustainability Indices (DJSI) questionnaire file.
